(19) United States
(12) Patent Application Publication
(10) Pub. No.: US 2009/0067305 A1
(43) Pub. Date: Mar. 12, 2009

(54) DUAL-BEAM LASER BEAM RECORDER, AND METHOD FOR CONTROLLING A DUAL-BEAM LASER RECORDER

(75) Inventor: Erwin R. Meinders, Eindhoven (NL)

Correspondence Address: Muncy, Geissler, Olds & Lowe, PLLC, P.O. BOX 1364, FAIRFAX, VA, 22038-1364, US

(73) Assignee: MOSER BAER INDIA LTD, New Delhi (IN)

(21) Appl. No.: 12/067,786

(22) PCT Filed: Sep. 15, 2006
(86) PCT No.: PCT/IB06/53308

§ 371 Date: Aug. 11, 2008

(30) Foreign Application Priority Data
Sep. 22, 2005 (EP) 05108779.9

(51) Int. Cl. G11B 7/00

(52) U.S. Cl. 369/47.53; G9B/7

(57) ABSTRACT

The present invention relates to a method for controlling a dual-beam LBR (Laser Beam Recorder) (56) suitable for mastering a record carrier (60) by writing data in the record carrier in circular or spiral tracks and comprising: means (58) for rotating a record carrier; means (62) for moving a dual-beam laser (61) over the record carrier (60) in a radial direction with reference to the rotation of the record carrier (60); means (65) for controlling the dual-beam laser output power; and means (66) for synchronizing the rotation of the record carrier (60), the movement of the dual-beam laser (61) and the dual-beam laser output power.

In accordance with the invention synchronizing the rotation of the record carrier 60; the movement of the dual-beam laser 61 and the dual-beam laser output power is performed such that at least a part of the data is written in at least one track comprising a different arrangement than circular or spiral.

The present invention also relates to a dual-beam Laser Beam Recorder adapted to carry out the method of the invention, and to the use of such a dual-beam Laser Beam Recorder to create a high density relief structure which at least in sections comprises a different arrangement than circular or spiral.

### FIELD OF THE INVENTION

The present invention relates to a method for controlling a dual-beam LBR (Laser Beam Recorder) suitable for mastering a record carrier by writing data in the record carrier in circular or spiral tracks and comprising: means for rotating a record carrier; means for moving a dual-beam laser over the record carrier in a radial direction with reference to the rotation of the record carrier; means for controlling the laser output power; and means for synchronizing the rotation of the record carrier, the movement of the dual-beam laser and the laser output power. Furthermore, the present invention relates to a dual-beam Laser Beam Recorder suitable for mastering a record carrier by writing data in the record carrier in circular or spiral tracks and comprising: means for rotating a record carrier; means for moving a dual-beam laser over the record carrier in a radial direction with reference to the rotation of the record carrier; means for controlling the dual-beam laser output power; and means for synchronizing the rotation of the record carrier, the movement of the laser and the laser output power.

The term “dual-beam laser” used herein is intended to cover every device that is suitable to create at least two laser beams which, preferably, can be created and/or varied independently. In most cases such a dual-beam laser will comprise two separate radiation sources. However, theoretically it is also possible to split a laser beam created by a single radiation source to end up with the at least two laser beams. Furthermore, in the present context the term record carrier is intended to be interpreted broadly. For example, it shall encompass every medium which is suitable to be provided with a two-dimensional high density relief structure. Such two-dimensional high density relief structures are, for example, necessary in the field of reticles for semiconductor processing, biosensor structures, masks, security papers, watermarks, micro-contact printing, optical storage, etc.

### BACKGROUND OF THE INVENTION

For example, E-beam patterning is a well-known technology to make two-dimensional high density relief structures. An electron-sensitive layer, deposited on a substrate, is illuminated with a focused electron beam. The exposed areas are dissolved in a developer to end LIP with a patterned layer, the so-called mask layer. In subsequent process steps, the substrate with mask layer is exposed to etchants for etching the underlying substrate (for example silicon). The silicon substrate is selectively etched such that the pattern present in the mask layer is transferred to the silicon. However, E-beam patterning is expensive and time-consuming.

As regards the field of optical storage, a main advantage is the cheap replication of ROM media. A major disadvantage of conventional optical storage concepts is the presence of rotating parts in the optical drives. Rotating parts have a lot of disadvantages, for example a sensitivity to wear, a creation of noise due to rotation, a consumption of rather high electrical power, in particular at high rotation speeds, etc. For example, the T-ROM concept, based on the Talbot effect, was proposed as an optical readout principle without rotating parts for use in an optical card system. This concept is based on a two-dimensional periodic light interference pattern that is generated through a matrix of equidistantly spaced holes. The optical card (for example a ROM medium) is located in this matrix of multiple light sources and a detector, for example a CCD-like detector. The optical card, i.e. the optical record carrier, is readout in a transmission mode. The unwritten areas transmit more light than the written areas (for example pits) or the other way around. In this way, binary data encoded in the transmission level of the different pixels can be readout. A main challenge is the manufacturing of suitable ROM media for such readers.

Laser Beam Recorders are well known in connection with the production of glass masters which form the basis for providing stampers used to replicate for example CDs or DVDs. A conventional Laser Beam Recorder (LBR) comprises a rotation table, on which the substrate is mounted, and a translation sledge on which the optical components are mounted. The optical components are used to shape and modulate the laser beam and focus the beam through an objective lens onto the substrate. When the substrate is rotated and the sledge is gradually pulled outside (or inside) a spiral remains. Conventionally, the laser beam is modulated with a certain frequency to obtain masters with a data pattern for prerecorded (ROM) media, or operated continuously to obtain masters with a pregroove for recordable and rewritable optical media. In addition, a deflector can be utilized to deviate the focused laser beam with respect to its nominal position such that the pregroove contains a wobble for data recovery. Dual-beam LBRs are equipped with a second laser beam to master, for example, pre-pits in the adjacent tracks of a pre-grooved disc (for example for DVD-R/RW and MO formats). The second laser beam can be closely aligned to the primarily beam. The two focused laser spots can be positioned at just half a track-pitch apart. In most optical formats, the mastering is done with a constant lineal velocity. This implies that the modulation frequency can be kept constant throughout mastering the entire disc. The physical pit lengths remain then constant from the inner to the outer part of the disc. A constant lineal velocity requires that the rotation frequency is continuously adapted to the actual position of the writing stylus. In contrast to optical drives where the pre-recorded and recordable discs are actively tracked (the ROM data and pregrooves are used for tracking) the Laser Beam Recorder has no active tracking. To fulfill the accuracy requirements of optical discs, the accuracy of the rotation of the substrate and the translation of the sledge (focused laser beams) are in the nanometer range. When the LBR is operated in constant angular velocity mode and a single tone is recorded, the synchronization comes for free. This mode can be used to write a synchronized two-dimensional data pattern. The pulse pattern should then be locked to a fixed reference, for instance the rotation of the master substrate (PPO). In conventional mastering, a thin photosensitive layer, spincoated on a glass substrate, is illuminated with a modulated focused laser beam in a Laser Beam Recorder. The modulation of the laser beam causes that some parts of the disc are being exposed by UV (or another wave length) light while the intermediate layers between the exposed areas (pits) remain unexposed. While the disc rotates and the focused laser beam is smoothly pulled to the outer side of the disc, a spiral of alternating illuminated areas remains, wherein it is also known to arrange the data in a circular arrangement. In other words, with known Laser Beam Recorders the data is arranged in spiral or circular tracks. Subsequently, the exposed areas are being developed in a so-called development process. Under influence of photons, acids are formed that dissolve in the base development liquids. This dissolution results in physical holes inside the photoresist layer. The layer thickness is a natural barrier for the created holes since the used glass is insensitive to UV exposure and the subsequent development liquid. Possible photoresists are Chemically-Amplified (CA) resist, Clariant, Ultra, Shipley, etc. Subsequently, a Ni layer is sputter-deposited on top of the patterned photoresist layer. This Ni layer is galvanically grown such that a rather thick stamper with inverse pit structure remains. This stamper is used to replicate discs, either via injection molding with, for example, polycarbonate or via a glass/2P replication process.

It is also possible to make a relief structure with phase-transition materials. These inorganic materials obtain a different morphology/lattice structure due to laser-induced heating. The thermally degraded and the initial phases have different dissolution rates when in contact with an etch liquid like alkaline liquids (KOH and NaOH) and acids (like HCl and HNO3). For example, amorphous areas may be written in an initially crystalline phase-change layer. Either the amorphous marks or the crystalline background material dissolves faster such that a relief structure remains. The phase-change layer is embedded in a phase-change recording stack, further comprising a metal heat sink layer and dielectric layer to fine-tune optical contrast and thermal response during writing. The phase-transition layer may also be used as a mask layer in combination with an etchable under-layer. Phase-transition mastering is an interesting candidate to further increase the density of a relief structure. With conventional electro-chemical plating, a stamper or metallic negative is made from the patterned relief structure. This stamper is made to replicate the pit structure in a polycarbonate disc or 2P/glass disc.

It is the object of the present invention to broaden the application area of dual-beam Laser Beam Recorders such that arbitrary two-dimensional high density relief structures can be formed on a record carrier, for example, but without being limited thereto, such that stampers for creating optical cards of the type mentioned at the beginning may be produced.

### SUMMARY OF THE INVENTION

This object is solved by the features of the independent claims. Further developments and preferred embodiments of the invention are outlined in the dependent claims.

In accordance with a first aspect of the present invention, the method for controlling a dual-beam Laser Beam Recorder of the type mentioned at the beginning comprises the step: synchronizing the rotation of the record carrier, the movement of the dual-beam laser and the laser output power such that at least a part of the data is written in at least one track comprising a different arrangement than circular or spiral.

In accordance with a second aspect of the present invention the object mentioned above is solved by a dual-beam Laser Beam Recorder of the type mentioned at the beginning, wherein the means for synchronizing the rotation of the record carrier, the movement of the dual-beam laser and the laser output power are adapted to perform synchronization such that at least a part of the data is written in at least one track comprising a different arrangement than circular or spiral.

Thereby, nearly any two-dimensional relief structures can be formed, for example a rectangular matrix of data pits arranged in a Cartesian-like grid. This for example results in a circular disc that can be produced by conventional mastering machines controlled and adapted, respectively, in accordance with the present invention, wherein a rectangular cut-out will provide the desired card with a rectangular matrix of data pits. It is preferred that at a fixed reference point in time the rotation of the disc is synchronized with the laser pulse pattern. If the disc, i.e. the record carrier, rotates at a constant angular velocity, the time of a revolution is fixed, namely T=1/f, f being the rotational frequency of the disc (angular frequency ω=2πf). The delay between the reference point in time and a pit P(i, j) is t=θ/ω. At time t, the write pulse is fired to write pixel or pit P(i, j). Alternatively, it is also possible to operate the Laser Beam Recorder in a constant linear velocity mode. In this case the angular velocity is adapted to obtain a constant linear velocity at all radii. As regards E-beam patterning mentioned at the beginning, the invention provides an alternative method that is based on two focused laser beams, preferably in combination with photo-sensitive or inorganic resist. The method utilizes a conventional dual-beam Laser Beam Recorder (LBR) that needs to be specifically programmed for this purpose such that the data patterns are synchronized. The spatial resolution of the proposed LBR technology is comparable to that achieved with E-beam pattern generators. A further advantage of using such an dual-beam LBR is the huge installed base of conventional dual-beam LBRs.

While the following features in most instances are only claimed in connection with the method of the invention, it is clear to the person skilled in the art, that these features may also be used advantageously in connection with the Laser Beam Recorder in accordance with the present invention.

It is preferred that for writing the part of the data a mapping between Cartesian coordinates and polar coordinates is performed. For a known data pattern, the to be written pits are known in terms of Cartesian coordinates. These locations of the pits (or any other data structure) can be transformed to polar coordinates (angle and radius) once the origin of the pattern is fixed. Subsequently the laser pulse train can be defined and synchronized with the rotation of the disc.

Without being limited thereto it is for example possible that the at least one track comprises an arrangement of a straight line. Tracks in the form of straight lines (especially equidistantly spaced parallel lines) are for example useful in connection with the production of optical cards intended to be readout without rotation.

For many fields of application it is preferred that the part of said data is provided in the form of pits. In most cases the physical pits will be formed via the conventional development and etching processes. However, it is also within the scope of the invention that the physical pits are directly formed by ablation.

For example in connection with data arranged in a Cartesian-like grid it is preferred that the pits are located at intersections of virtual lines lying in the plane of the record carrier and virtual columns lying in the plane of the record carrier.

In some fields of application it may be advantageous that at least some of the pits overlap. If numerous circularly shaped spots overlap, pits (much) larger than the optical spot of the laser can be written. This for example may be of interest for the first generation optical card readers in which the data resolution may be limited by the readout channel of the reader.

In accordance with a further embodiment of the present invention it is possible that at least some of the pits have different depths. By providing pits having different depths it is possible to create ROM media with basically more than two transmission/reflection levels to increase the data density.

In this connection it is preferred that at least part of said data is provided in the form of pits having different depths, wherein the record carrier comprises a first recording layer and at least a second recording layer between which there is provided a physical barrier leading to discrete pit depths. The recording layers are preferably made of photoresist material. It is to be noted that the invention is not limited to using only two recording layers for creating two different depths levels, but embraces also record carriers having more than two recording layers for providing a corresponding number of different transmission/reflection levels. In accordance with a first general solution the physical barrier comprises an interface layer that breaks down by a predetermined break down mechanism, particularly by a photo-chemical reaction or a thermal effect. It should be clear that in cases where more than two recording layers are provided a suitable interface layer is preferably arranged between all adjacent recording layers. In cases where the break down mechanism is a thermal effect, the optical properties of the record carrier for example change due melting, thermal degradation or other thermal alteration mechanism. A further development of the first general solution is that the interface layer is bleachable by a certain amount of photons, wherein the bleached material is solvable in a developer used in the photo-chemical reaction. It is also possible that the interface layer is an inhibition layer which becomes sensitive above a predetermined laser power. For example, a first photoresist layer can be spincoated, baked and treated with a pre-development. Then, a second photoresist layer is spincoated and baked. The inhibition layer was initially part of the first photoresist layer but obtained different chemical (and optical) properties due to the treatment with the development liquid during the pre-development. The interface layer is preferably made from a material selected from the following group: PMMA, silicon nitride, aluminum nitride, ZnS—SiO2. In accordance with a second general solution the physical barrier is formed in that the first recording layer and the second recording layer are made from intrinsic different materials. In this case the different recording layers are for example spincoated or deposited on top of each other. For example, the first recording layer and the second recording layer may comprise different photosensitive compounds. Furthermore, it is possible that the first recording layer and the second recording layer comprise different compositions. Additionally or alternatively it is possible in connection with the second general solution that the first recording layer and the second recording layer comprise different sensitivities with respect to laser (for example deep UV) illumination. It is for example possible to spincoat a photoresist having a lower sensitivity onto a substrate to form a second recording layer, and to subsequently spincoat a photoresist having a higher sensitivity onto the second recording layer to form a first recording layer, wherein in this case the second recording layer is only reached at high laser power levels. Another possibility is that the first recording layer and the second recording layer comprise different sensitivities with respect to a photo-chemical development. It is also possible that the first recording layer and the second recording layer comprise different sensitivities with respect to different etching agents. For example, the first recording layer may be formed by a photoresist and the second recording layer may be formed by a glass substrate.

A multi-level relief structure can also be formed with phase-transition materials. In that case, more phase-transition recording layers are combined in one recording stack. The application of different power levels results in writing of marks in the first recording layer (low laser power) or in the second recording layer (high laser power). The well-known phase-change materials are very suitable to make a two-level relief structure. A recording stack for such a two-level structure comprises a first dielectric layer, a first phase-change layer, a first interface layer, a second phase-change layer, a second interface layer and a metal heat sink layer.

The invention also embraces solutions where the part of data is written in the form of a straight line comprising local broadenings. For example the data may be provided in form of continuous grooves with local broadenings, wherein the broadenings are obtained via laser pulses that are super-imposed on a continuous layers power.

Additionally or alternatively it is possible that the part of data is written in the form of a straight line comprising local necks. For example continuous grooves with local narrowings may be formed, wherein these narrowings are obtained via laser power variation.

Without being limited thereto it is preferred that the record carrier is intended to be used in connection with the creation of a stamper. A stamper is typically a nickel substrate with protruding bumps representing the data. After the data is written in the record carrier the exposed/illuminated areas are chemically removed via etching, such that physical pits remain in the resist layer. The obtained relief structure is provided with a sputter-deposited metallic layer, preferably nickel. This Ni layer is grown to a thick and manageable substrate via electro-chemical plating. The Ni substrate is separated from the master substrate to end up with the stamper. The stamper may for example be used subsequently to replicate optical storage media. It is also possible to grow a stamper family on the basis of the high density relief structure.

In this context it is especially possible that the stamper is intended to be used for producing optical record carriers which are intended to be readout without being rotated. The optical record carriers may for example be optical cards intended to be readout via the Talbot effect as mentioned at the beginning.

In accordance with a different field of application the stamper is intended to be used for printing, especially for micro-contact printing. If the patterned substrate serves as stamp(er), an additional thin coating can be applied to improve or reduce the wetting properties of the information side of the stamp(er).

To further increase the data density it is possible that the track is a meta-track comprising a two dimensional data layout. The two-dimensional data storage in the disc plane is a novel way to increase capacity. The anticipated data capacity of a two-dimensional data storage is estimated to be at least at a factor 2.

It is also possible that the data is written into a layer of the record carrier which is intended to be used as a mask layer for an etch step. Such an etch step can, for example, be part of the process for making an integrated circuit (IC). The two-dimensional information contained in the mask layer can be transferred to an underlying substrate via wet or dry etching. After etching, the mask layer is removed and a patterned substrate remains. The photoresist layer may, for example, be directly deposited on a Si substrate. After patterning, the Si substrate may be etched with a dry etch step (for instance with O2 or Fluorine plasma). It is also possible to provide the substrate with an interface layer. The patterned mask layer is then situated on top of the interface layer. This interface layer needs to be etched as well. It is also possible that the patterned layer serves as mask layer for a further illumination of the substrate. For example, the mask plus substrate serves as a reticle for IC processing.

It is highly preferred that at least one of the two laser beams is deflected to enhance the spatial resolution. In general, a deflector increases the span of the focused laser spot during one passage of the spot. The deflection of the beam is very fast (up to 40 MHz in combination with 200 nm amplitude deflection is possible, the speed of deflection can be increased on the cost of the deflection amplitude). To write the data, at a fixed reference point in time, the rotation of the disc is synchronized with the laser pulse pattern. If the disc rotates at a constant angular velocity, the time of one revolution is fixed, namely T=1/f, f being the rotational frequency of the disc (angular frequency ω=2πf). The delay between the reference point and Pit P(i,j) is t=θ/ω. At time t, the write pulse is fired to write pixel or pit P(i,j). It is also possible to operate the LBR in constant linear velocity mode. The angular velocity is then adapted to obtain a constant linear velocity at all radii. For a known data pattern, the to be written pits are known in terms of Cartesian coordinates, as mentioned above. These locations of the pits are transformed to polar co-ordinates (angle and radius) once the origin of the pattern is fixed. Subsequently the laser pulse train can be defined and synchronized with the rotation of the disc. If a very low track pitch is selected for a single-beam LBR, for instance 10 nm, theoretically no deflection is required to achieve a position resolution of 10 nm. The spot size is 150 nm based on a deep UV LBR recorder (257 nm wavelength and an NA=0.9, with liquid immersion mastering, the NA of the spot can be further increased to NA=1.2). Features (lines) with width of 150 nm can be written. The position accuracy is about 10 nm. However, the total recording time is between 60 hours (2 m/s recording velocity) and 20 hours (5 m/s recording velocity). If a track pitch of 400 nm is selected with no deflection or second laser beam, the position accuracy is less than 200 nm and in most cases unacceptable. If the track pitch is 400 nm, a deflection of 200 nm is possible. The deflection frequency is 40 MHz, corresponding to 25 ns deflection time. In case of a linear velocity of 2 m/s, 25 ns corresponds to 50 nm displacement. The total recording time is 2 hours. In combination with a dual-beam LBR deflection of at least one laser beam makes all positions possible.

Every stamper for making optical data carriers made on the basis of the method in accordance with the invention, every optical data carrier made on the basis of such a stamper, every stamp(er) for micro-contact printing made on the basis of the method in accordance with the invention, every print made on the basis of such a stamp(er), every mask for an etching step made on the basis of the method in accordance with the invention, and every high density relief structure comprising a different arrangement than circular or spiral and being made on the basis of the method in accordance with the invention is intended to fall in the scope of the accompanying claims.

The same relates to every use of a dual-beam LBR (Laser Beam Recorder) to make a high density relief structure on a record carrier, wherein the high density relief structure at least in sections comprises a different arrangement than circular or spiral.

These and other aspects of the invention will be apparent from and elucidated with reference to the embodiments described hereinafter.

### BRIEF DESCRIPTION OF THE DRAWINGS

FIG. 1 is a flow chart illustrating an embodiment of the method in accordance with the invention;

FIG. 2 schematically illustrates a Laser Beam Recorder in accordance with the invention, wherein the Laser Beam Recorder is also suitable to carry out the method in accordance with the invention;

FIG. 3A illustrates a record carrier comprising a rectangular matrix of pits;

FIG. 3B schematically shows a spiral trajectory of a stylus;

FIG. 3C shows a trajectory of an optical stylus and an overlapping two-dimensional data pattern;

FIG. 3D illustrates the writing of the marks by positioning the laser at a nominal position imposed by the track-pitch of a spiral, and at a deviated position with respect to the nominal position, for example by using a deflector;

FIG. 4A illustrates data lines with pre-recorded pits;

FIG. 4B shows the data line 20 of FIG. 4A;

FIG. 4C shows the laser pulse pattern used to create the data line in accordance with FIG. 4B;

FIG. 5A shows a different embodiment of data lines with pre-recorded pits;

FIG. 5B shows the data line 22 of FIG. 5A;

FIG. 5C shows the laser pulse pattern used to create the data line in accordance with FIG. 5B;

FIG. 6 shows a two-dimensional relief structure obtained by writing continuous grooves via synchronized positioning of partially overwriting marks;

FIG. 7 is a top view of a two-dimensional meta track;

FIG. 8 is a flow chart illustrating in more detail the synchronisation in accordance with the invention for a case in which pits with different depths are written;

FIG. 9 schematically illustrates the above mentioned first general solution, wherein the record carrier is depicted in a sectional view, and it also illustrates the application of two different laser power levels;

FIG. 10A illustrates the record carrier of FIG. 9 after development and etching in a sectional view;

FIG. 10B schematically shows a stamper made on the basis of the record carrier in accordance with 10A;

FIG. 11 is a top view of a multilevel pit pattern;

FIG. 12 is a top view of a two-dimensional multilevel meta track;

FIG. 13 shows an atomic force microscopy picture of a DVD-R/RW data pattern with pre-pits; and

FIG. 14 shows atomic force microscopy pictures of a BD-ROM data pattern with a deflection of 80 nm (25 GB BD-ROM tangential density), written with a single-beam LBR.

### DESCRIPTION OF PREFERRED EMBODIMENTS

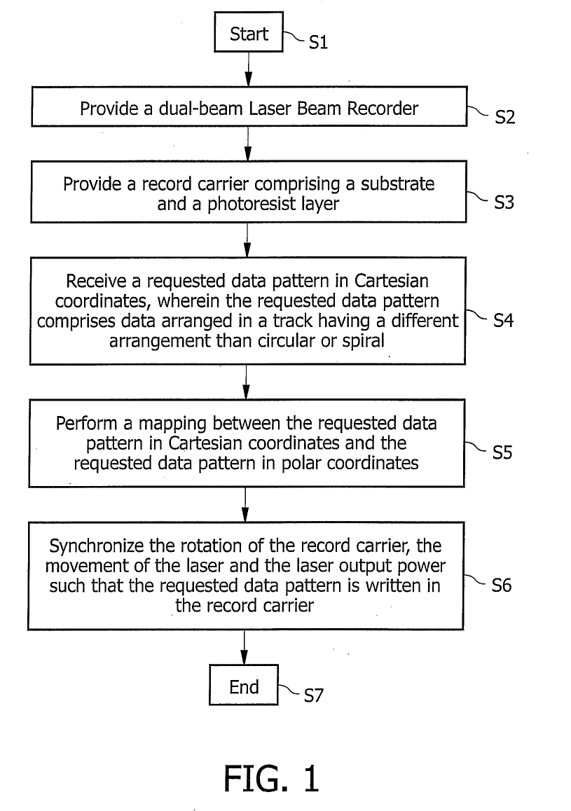

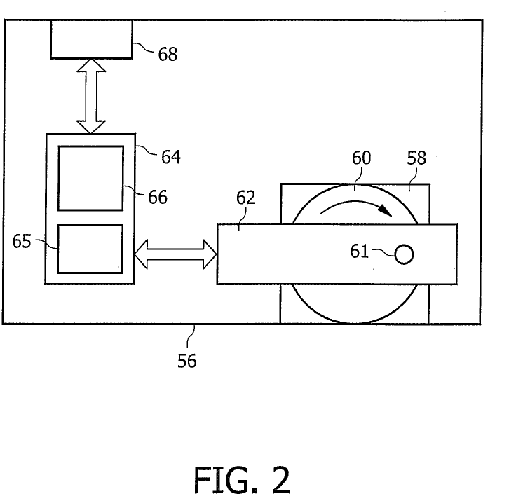

FIG. 1 is a flow chart illustrating an embodiment of the method in accordance with the invention. The illustrated method starts in step S1. In step S2 a dual-beam Laser Beam Recorder is provided which will be described in greater detail with reference to FIG. 2. In step S3 a record carrier comprising a substrate and a recording stack is provided. For conventional mastering, the recording stack comprises a photoresist layer. It should be clear that optionally other layers may also be provided, for example layers to improve the absorption of the laser light and to improve the pit shape. It is also possible to use a master substrate based on phase-transition materials. Furthermore, it should be clear that in cases where pits comprising different depths are to be created, record carriers comprising a corresponding number of recording layers may be used. In step S4 a requested data pattern is received in Cartesian coordinates. The requested data pattern comprises data arranged in a track having a different arrangement than circular or spiral. In step S5 a mapping between the requested data pattern in Cartesian coordinates and the requested data patterned in polar coordinates is performed. As is it well known, between Cartesian and polar coordinates there exists the following relation: x=R cos(θ) and y=R sin(θ). In step S6 the rotation of the record carrier, the movement of the dual-beam laser and the laser output power is synchronized such that the requested data pattern is written in the record carrier. The method depicted in FIG. 1 ends in step S7.

FIG. 2 schematically illustrates a dual-beam Laser Beam Recorder in accordance with the invention, wherein the dual-beam Laser Beam Recorder 56 is also suitable to carry out the method in accordance with the invention. The Laser Beam Recorder 56 comprises means 58 for rotating a record carrier 60. A dual-beam laser 61 is movable in the radial direction with respect to the rotation of the record carrier 60 by means 62. The second laser beam of the dual-beam laser beam recorder can be closely aligned to the primarily beam. The two focused laser spots can be positioned at just half a track-pitch apart. Furthermore, there is provided a controller 64 for controlling the operation of the Laser Beam recorder 56. The controller 64 is coupled to an interface 68 for receiving the requested data pattern in Cartesian coordinates. The controller 64 (beside the typical circuitry which is not shown) comprises means 65 for controlling the laser output power and means 66 for synchronizing the rotation of the record carrier 60, the radial movement of the laser 61 and the laser output power such that at least a part of the data is written in at least one track comprising a different arrangement than circular or spiral. The controller 64 preferably is realized on the basis of at least one micro processor interacting with suitable software. At least in some cases it is regarded as possible to enable existing Laser Beam Recorders to realize the present invention only by a firmware upgrade. In other cases it will be necessary to exchange or add hardware to enable an existing Laser Beam Recorder to carry out the present invention.

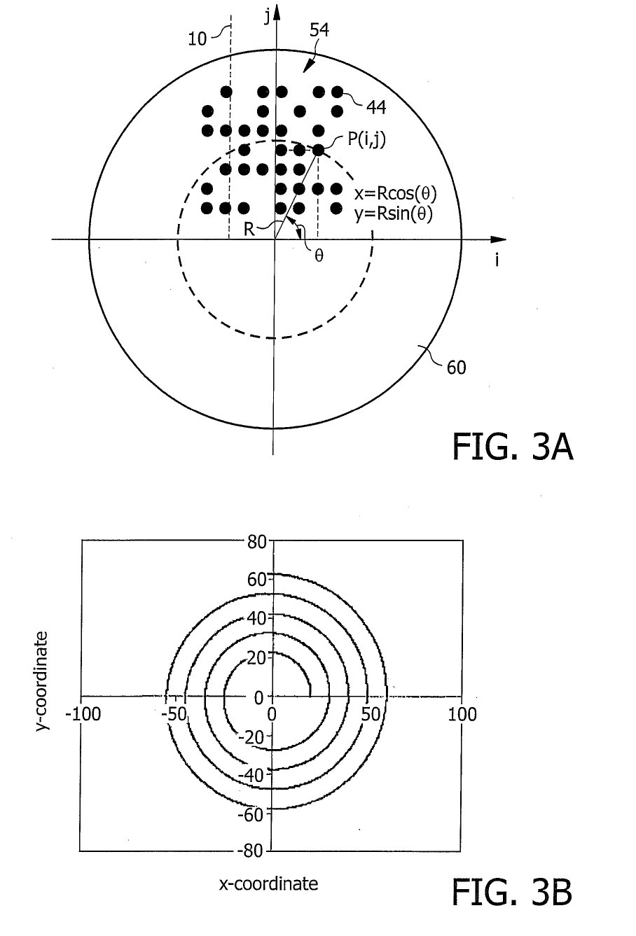

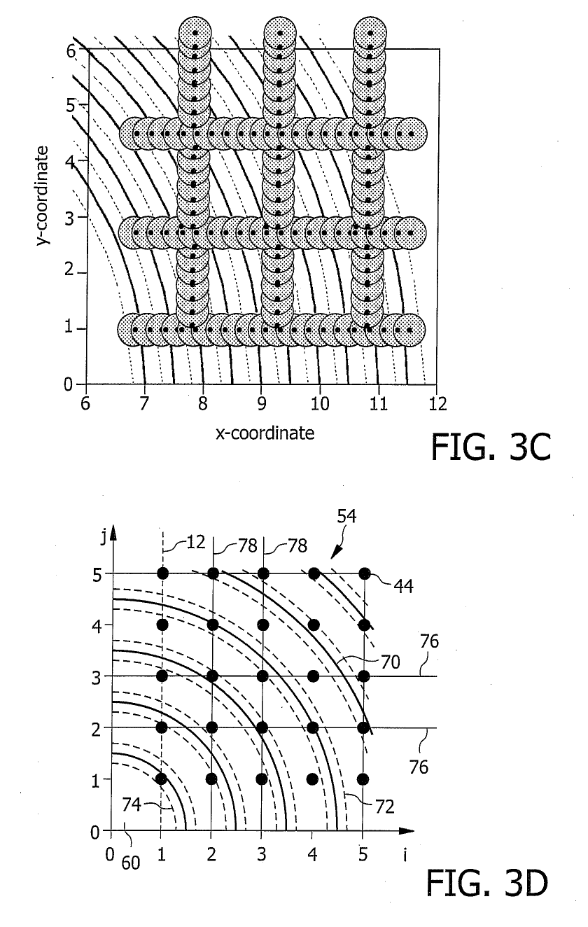

FIG. 3A shows an example of a rectangular data pattern 54 of pits 44 written on a record carrier 60. The Cartesian coordinates of a pit P(i, j) are x=R cos (θ) and y=R sin (θ). The rectangular data pattern 54 is created by writing the pits in straight tracks, wherein only one track 10 is shown.

FIG. 3B shows a trajectory of a first order approach, wherein the optical stylus follows a spirally shaped trajectory. This is referred to as the nominal position of the stylus. The radius of the spiral is expressed as: r_spot=r_init+t/T*TP, where r_init is the initial radius, t is the elapsed time, T is the period for one revolution, TP is the distance between adjacent tracks (track pitch). The angle θ of the stylus is expressed as: θ_spot=θ_init+t/T*2π.

If the spiral of FIG. 3B is mapped on a preferred two-dimensional pattern, the sketch given in FIG. 3C is obtained. The resolution that can be achieved depends very much on the optical spot size and the track pitch of writing. For the two-dimensional pattern in FIG. 3C, a much smaller track pitch is required to write the pattern with the required spatial accuracy. In FIG. 3C the schematic of the trajectory of an optical stylus and an overlapping two-dimensional pattern are given. The solid lines indicate the nominal trajectory; the dotted lines are the outer bonds of the stylus when at least one laser beam is deflected.

FIG. 3D shows an example of a rectangular data pattern 54 of pits 44 that is written on a record carrier 60. The pits are arranged at intersections of lines and columns of which only two lines 76 and two lines 78 are shown. In this case, the columns form straight tracks of which one track is indicated at 12. The focused laser spots of the dual-beam Laser Beam Recorder can in fact cover the entire master substrate To write the data pattern 54 the Laser Beam Recorder is operated such that the two laser spots are slowly moved outwards. It should be clear that the two laser beams of the dual-beam LBR are not necessarily active simultaneously. Furthermore, it is possible to modulate the laser beams such that marks of different lengths are written.

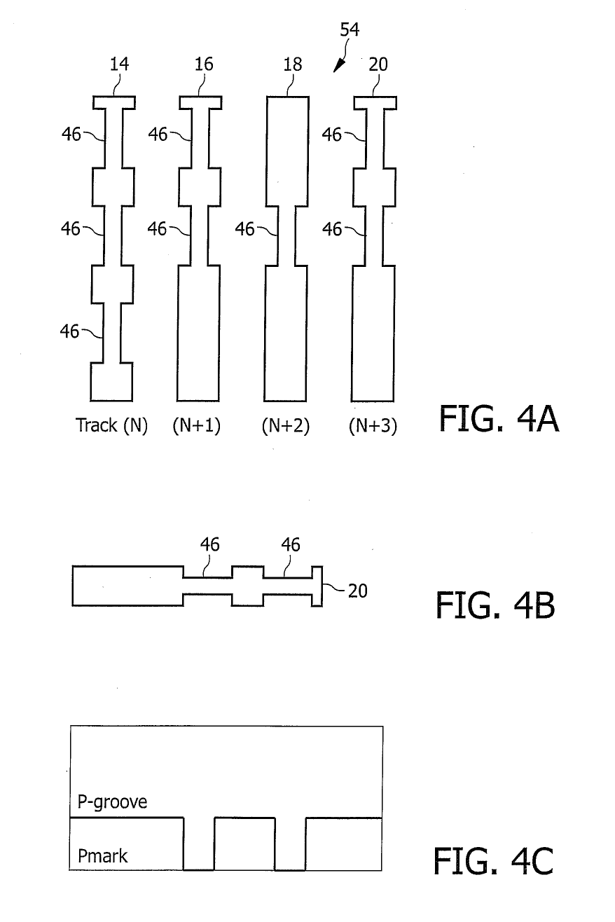

FIG. 4A illustrates data lines with pre-recorded pits, FIG. 4B shows the data line 20 of FIG. 4A and FIG. 4C shows the laser pulse pattern used to create the data line in accordance with FIG. 4B. As regards the write strategy, the pulse power is not given as a function of time but as a function as the Cartesian coordinates. The pulse power as a function of time is derived from the mapping that follows from the synchronized writing.

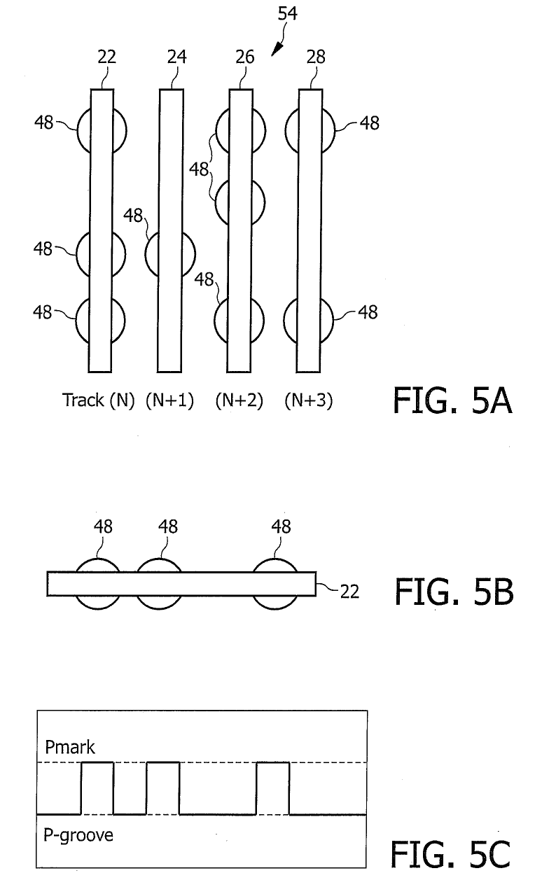

FIG. 5A shows a different embodiment of data lines with pre-recorded pits, FIG. 5B shows the data line 22 of FIG. 5A and FIG. 5C shows the laser pulse pattern used to create the data line in accordance with FIG. 5B. Also in this case the pulse power is not given as a function of time but as a function of the Cartesian coordinates, wherein the pulse power as a function of time again is derived from mapping that follows from the synchronized writing.

The examples shown in FIGS. 4 and 5 can for example be used for a flash ROM card.

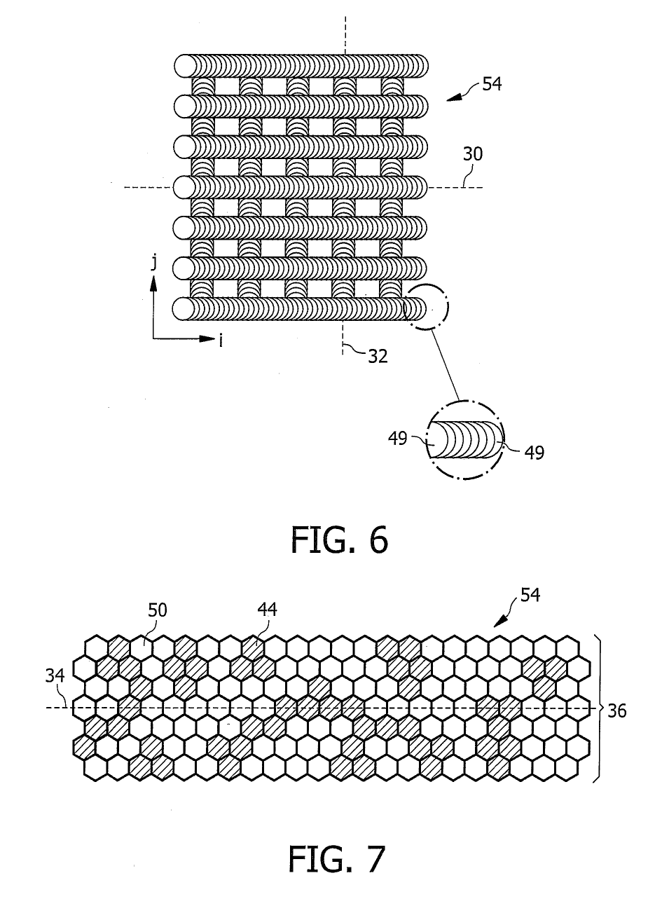

FIG. 6 shows a two-dimensional relief structure 54 obtained by writing continuous grooves via synchronized positioning of partially overwriting marks 49 arranged in straight tracks 30, 32.

FIG. 7 shows an example of a two-dimensional data pattern 54 which is provided in form of a straight meta-track 36 which is formed by a plurality of adjacent straight tracks 34. Besides the matrix level 50 (back-ground material) there do exist only pits 54 which all comprise the same depth.

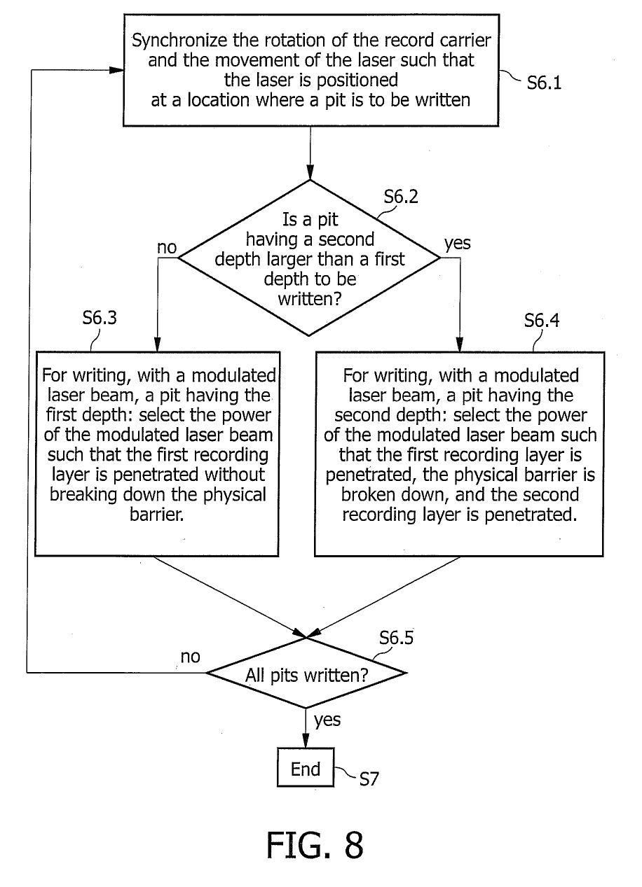

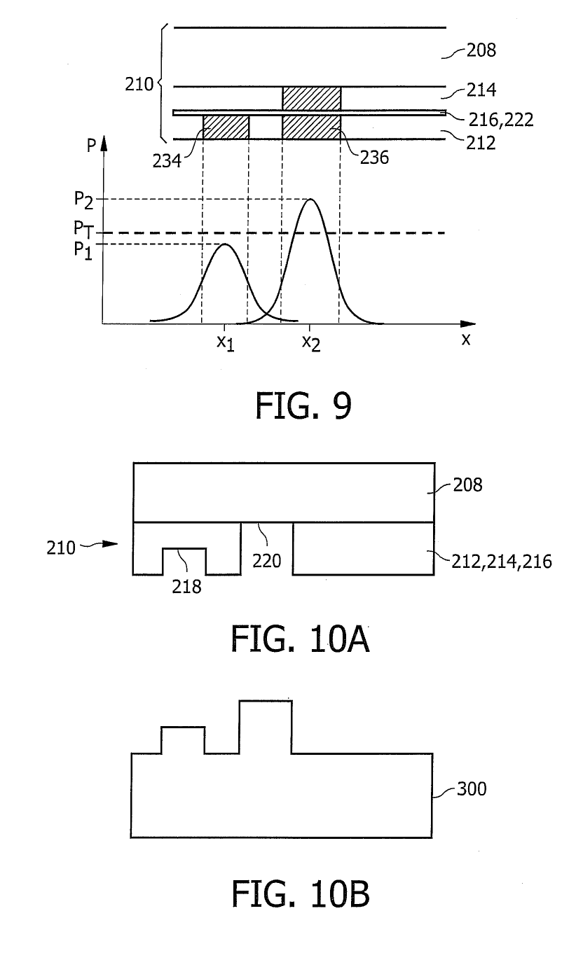

FIG. 8 is a flow chart illustrating in more detail the synchronisation in accordance with the invention for a case in which pits with different depths are written. The steps shown in FIG. 8 may for example substitute step S6 of FIG. 1. The method illustrated in FIG. 8 may for example be carried out with a record carrier as illustrated in FIG. 9. Such a record carrier 210 comprises a substrate 208 on which a second photoresist recording layer 214 is spincoated. An interface layer 222 forming a physical barrier 216 is provided between the second recording layer 214 and a first recording layer 212, which is also formed by a photoresist. With such a record carrier 210 the method in accordance with FIG. 8 may be carried out in the following way.

In step S6.1 the rotation of the record carrier and the movement of the laser is synchronized such that the laser is positioned at a location where a pit is to be written.

In step S6.2 it is determined whether a pit of a second depth larger than a first depth is to be written. If this is not the case, the method proceeds to step S6.3.

In step S6.3, for writing a pit 234 (FIG. 9) having the first depth, the power of the modulated laser beam is selected such that the first recording layer 212 (FIG. 9) is penetrated without breaking down the physical barrier 216 (FIG. 9). This laser power level is indicated as P₁ in FIG. 9.

If it is determined in step S6.2 that a pit having a second depth larger than the first depth is to be written, it is proceeded to step S6.4.

In step S6.4, for writing a pit 236 (FIG. 9) having the second depth, the power of the modulated laser beam is selected such that the first recording layer 212 (FIG. 9) is penetrated, the physical barrier 216 (FIG. 9) is broken down, and the second recording layer 214 (FIG. 9) is penetrated. A suitable laser power level for creating the pit 236 is indicated as P₂ in FIG. 9, wherein the power level P₂ is higher than a threshold power level P_{T} which is required for breaking down the physical barrier 216.

In accordance with FIG. 8 it is determined in step S6.4 whether all pits have been written. If this is the case, the method ends in step S7 (FIG. 1). If further pits have to be written, the method again proceeds with step S6.1.

FIG. 10A shows the record carrier 210 of FIG. 9 after the development. For developing the record carrier 210 based on photoresist it is flushed with development liquid (KOH, NaOH, or other alkaline liquid) which leads to a dissolution of the acid molecules leaving physical holes inside the recording layer. The resulting record carrier 210 comprises discrete pit depths 218, 220. For phase-transition mastering, both alkaline liquids (NaOH, KOH) and acids (HCl, HNO3) can be used as etch liquid to form a relief structure.

FIG. 10B shows a stamper which is made on the basis of the optical record carrier 210 of FIG. 10A. To produce the stamper 300 a metallic layer is sputter-deposited over the record carrier 210, wherein the metal preferably is nickel. This nickel layer is grown to a thick and manageable substrate via electro-chemical plating. Subsequently the nickel substrate is separated from the record carrier 210 (master substrate) to end up with the stamper 300.

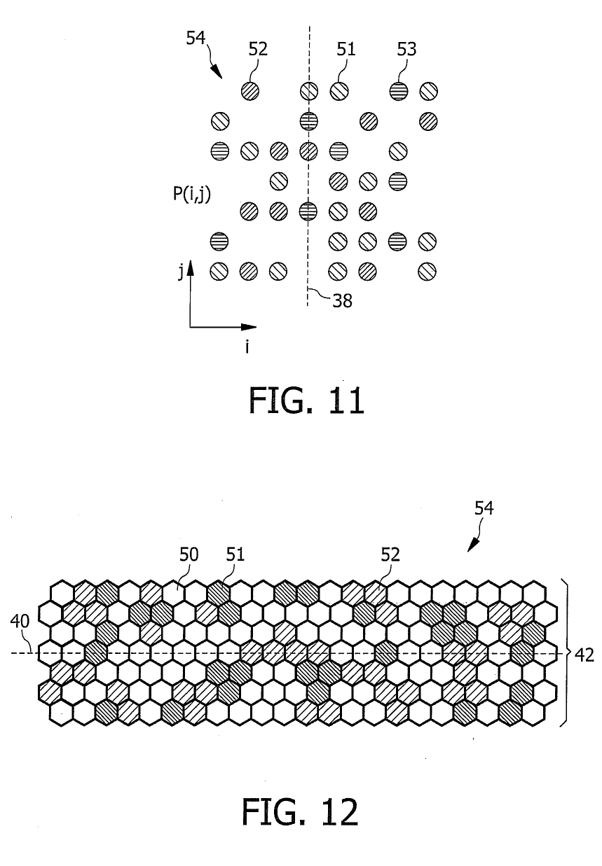

FIG. 11 shows a top view of a multi level pit pattern. The data 54 is arranged in straight tracks such that a rectangular matrix of pits 51, 52, 53 is formed. The pits 53 are deeper than the pits 51. Furthermore, the pits 53 are deeper than the pits 52. Such a data pattern can for example be formed with a record carrier having three recording layers with two physical barriers arranged between them.

FIG. 12 shows atop view of a two-dimensional multilevel meta-track. The two-dimensional multi-level data pattern 54 comprises pits 51 and 52 having different discrete depths relative to the unwritten area 50. The two-dimensional-multi-level meta-track 42 is formed by a plurality of adjacent straight tracks 40.

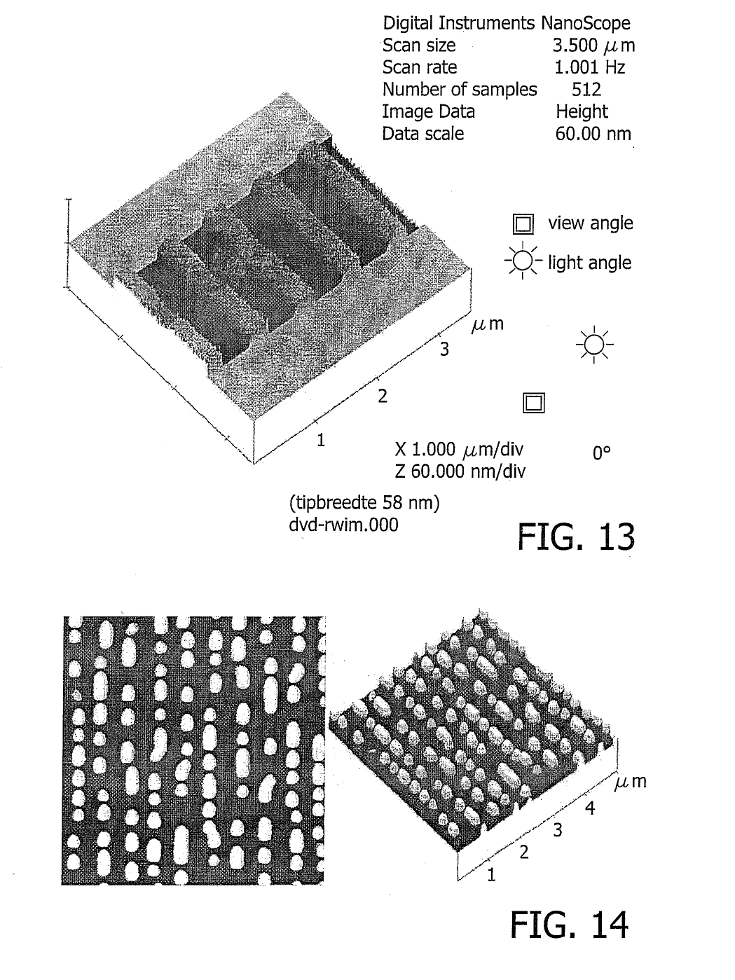

FIG. 13 shows an atomic force microscopy picture of an example of a pre-grooved DVD-R/RW disc with a data pattern comprising a pre-pit, wherein the data pattern was written with a dual-beam LBR. The second laser beam is closely aligned to the primarily beam. The two focused laser spots can be positioned at just half a track-pitch apart. Such a dual-layer LBR is conventionally used to write the pre-pits in all kind of optical recording formats, like the DVD-R and MO discs. However, in accordance with the invention the dual-beam LBR can be used to create arbitrary data pattern, as discussed above.

For comparison only, FIG. 14 shows a data pattern written with a single-beam LBR comprising a deflector. The deflector increases the span of the focused laser spot during one passage of the spot. The deflection of the beam is very fast (up to 40 MHz in combination with 200 nm amplitude deflection is possible, wherein the speed of deflection can be increased on the cost of the deflection amplitude). During mastering of the illustrated BD-ROM data, the beam was 80 nm deflected with a 15 MHz frequency, leading to a deformed pit. The deformation occurs in 1T of the data pit (corresponds to 13 MHz frequency).

In general, the absolute accuracy is important if a two-dimensional high density data pattern is recorded. All errors will accumulate and if no calibration is performed on the fly (during recording of the two-dimensional image), the positioning accuracy may become unacceptable. Three main contributions to the absolute positioning accuracy are recognized: the timing of the laser pulses, the accuracy of the nominal and relative positions of the laser beams. An accurate timing of the data pattern is ensured for each revolution because of the locked rotation and the synchronization of the pulse pattern with the rotation of the disc. The track-to-track variation is very low, 3σ values of 10 nm are characteristic for a thick-stone LBR. This corresponds to about 10 nm track variation for a 320 nm TP disc over the entire 120 mm surface. At micro scale, the accuracy is much better. The deflection frequency of the deflector and the response characteristics determine the relative position accuracy. This is also in the nanometer range.

Finally, it is to be noted that equivalents and modifications not described above may also be employed without departing from the scope of the invention, which is defined in the accompanying claims.

1-25. (canceled)

26. A method for controlling a dual-beam LBR (Laser Beam Recorder) suitable for mastering a record carrier by writing data in the record carrier in circular or spiral tracks and comprising:
means for rotating a record carrier;
means for moving a dual-beam laser over the record carrier in a radial direction with reference to the rotation of the record carrier;
means for controlling the laser output power; and
means for synchronizing the rotation of the record carrier, the movement of the dual-beam laser and the laser output power;
the method being characterized by the following step: synchronizing the rotation of the record carrier, the movement of the dual-beam laser and the laser output power such that at least a part of the data is written in at least one track comprising a different arrangement than circular or spiral.

27. The method according to claim 26, wherein for writing the part of the data a mapping between Cartesian coordinates and polar coordinates is performed.

28. The method according to claim 26, characterized in that the at least one track comprises an arrangement of a straight line.

29. The method according to claim 26, characterized in that the part of said data (54) is provided in the form of pits.

30. The method according to claim 29, characterized in that the pits are located at intersections of virtual lines lying in the plane of the record carrier and virtual columns lying in the plane of the record carrier.

31. The method according to claim 29, characterized in that at least some of the pits overlap.

32. The method according to claim 29, characterized in that at least some of the pits have different depths.

33. The method according to claim 26, characterized in that at least part of said data is provided in the form of pits having different depths, wherein the record carrier comprises a first recording layer and at least a second recording layer between which there is provided a physical barrier leading to discrete pit depths.

34. The method according to claim 26, characterized in that the part of data is written in the form of a straight line comprising local broadenings.

35. The method according to claim 26, characterized in that the part of data is written in the form of a straight line comprising local necks.

36. The method according to claim 26, characterized in that the record carrier is intended to be used in connection with the creation of a stamper.

37. The method according to claim 36, characterized in that the stamper is intended to be used for producing (optical) data carriers which are intended to be readout without being rotated.

38. The method according to claim 36, characterized in that the stamper is intended to be used for printing, especially for micro-contact printing.

39. The method according to claim 26, characterized in that the track is a meta-track comprising a two dimensional data layout.

40. The method according to claim 26, characterized in that the data is written into a layer of the record carrier which is intended to be used as a mask layer for an etch step.

41. The method according to claim 26, characterized in that at least one of the two laser beams is deflected to enhance the spatial resolution.

42. A stamper for making optical data carriers made on the basis of the method according to claim 26.

43. An optical data carrier made on the basis of the stamper according to claim 42.

44. A stamp(er) for micro-contact printing made on the basis of the method according to claim 26.

45. A print made on the basis of the stamp(er) according to claim 44.

46. A mask for an etching step made on the basis of the method according to claim 26.

47. A high density relief structure made on the basis of the method according to claim 26, wherein the high density relief structure at least in sections comprises a different arrangement than circular or spiral.

48. Use of a dual-beam LBR (Laser Beam Recorder) to make a high density relief structure on a record carrier, wherein the high density relief structure at least in sections comprises a different arrangement than circular or spiral.

49. A dual-beam LBR (Laser Beam Recorder) suitable for mastering a record carrier; by writing data in the record carrier in circular or spiral tracks and comprising:
means for rotating a record carrier;
means for moving a dual-beam laser over the record carrier in a radial direction with reference to the rotation of the record carrier;
means for controlling the laser output power; and
means for synchronizing the rotation of the record carrier, the movement of the dual-beam laser and the laser output power;
characterized in that the means for synchronizing the rotation of the record carrier, the movement of the dual-beam laser and the laser output power are adapted to perform synchronization such that at least a part of the data is written in at least one track comprising a different arrangement than circular or spiral.

50. An LBR according to claim 49, characterized in that the means for synchronization are adapted to perform a mapping between Cartesian coordinates and polar coordinates.
